(19) United States
(12) Patent Application Publication
(10) Pub. No.: US 2025/0305869 A1
(43) Pub. Date: Oct. 2, 2025

(54) SCALE ZEROING FOR SELF-CHECKOUT SYSTEMS

(71) Applicant: TOSHIBA GLOBAL COMMERCE SOLUTIONS, INC., Durham, NC (US)

(72) Inventor: Christopher J. NACK, Cary, NC (US)

(21) Appl. No.: 18/619,332

(22) Filed: Mar. 28, 2024

(51) Int. Cl. G01G 23/16; G01G 19/414

(52) U.S. Cl. CPC G01G 23/16; G01G 19/4144

(57) ABSTRACT

Methods and apparatus for performing zeroing of a scale of self-checkout system are described. One example method includes detecting a weight on a scale of a self-checkout system and determining that there is no object located on the scale. A zeroing operation of the scale is performed in response to detecting the weight on the scale and determining there is no object located on the scale.

### BACKGROUND

Self-checkout systems are often sold as modular systems that can be configured in different ways. For example, a self-checkout system may include a shelf for holding a shopping basket, a scanner for scanning items a customer wishes to purchase, a bagging area for placing the items in bags after they have been scanned, and a point-of-sale (POS) device for processing the payment for the items scanned by the customer. Additionally, a self-checkout system may include a security scale (also referred to as a bagging scale) in the bagging area for validating that an item placed in the bagging area has been scanned by the customer.

### BRIEF DESCRIPTION OF THE DRAWINGS

FIG. 1 illustrates an example self-checkout system, according to one embodiment.

FIG. 2 is a flowchart of a method for performing a zeroing of a scale of a self-checkout system, according to one embodiment.

FIGS. 3A and 3B illustrate an example scenario for performing zeroing of a scale of a self-checkout system, according to one embodiment.

### DETAILED DESCRIPTION

Self-checkout systems may employ security scales to validate that an item placed in a bagging area has been scanned by a customer. For example, a self-checkout system may use a security scale to determine if the weight of the item that was placed on the scale falls into a range of acceptable weights for that item. One potential issue with security scales is that, in some cases, a security scale may be susceptible to false detection of weight on the scale which may be caused by a malfunctioning or defective load sensor(s), environmental factors, low battery, or surface unevenness, as illustrative, non-limiting examples.

The false detection of weight on the scale may trigger the self-checkout system to mistakenly conclude that an unscanned item has been placed in the bagging area. In such instances, the self-checkout system may request the customer to remove a “non-existent” item(s) from the bagging area and may not allow the customer to scan item(s) until the “non-existent” item(s) is removed from the bagging area. Consequently, the self-checkout system may be taken out-of-service by store personnel, reducing the efficiency of the checkout process in the retail store and degrading customer experience.

Additionally, in some cases, it can take a significant amount of resources for a retail store to resolve issues with self-checkout systems that are malfunctioning due to false detection of non-existent items by security scales. In some situations, for example, store personnel may have to manually intervene with the self-checkout system to take the self-checkout system out-of-service and resolve the issue. Further, in situations where store personnel are unable to resolve the issue, store personnel may have to manually open a support ticket to request a technician to diagnose and resolve the issue. In these situations, the retail store may incur significant costs associated with sending a field technician to the retail store to resolve the issue.

Embodiments herein describe techniques for detecting when a scale of a self-checkout system is false detecting a “non-existent” item on the scale and for performing a zeroing operation of the scale to return the scale to zero when there is no item(s) on the scale. As described herein, the zeroing operation may involve determining a false detected weight on the scale, setting a “temporary zero weight” parameter of the scale equal to the false detected weight, and resetting the weight of the scale to a difference between the temporary zero weight parameter and the false detected weight.

In some embodiments, the self-checkout system may use one or more camera devices to detect whether there is an item(s) on the scale of the self-checkout system. The camera device(s) may include camera device(s) of the self-checkout system, camera device(s) of an environment in which the self-checkout system is located, camera device(s) coupled to (or associated with) another computing system within the environment, or a combination thereof. In some embodiments, the camera device(s) may include an artificial intelligence (AI)/machine learning (ML) engine configured to perform object detection within a field-of-view (FOV) of the camera device(s). The camera device(s) may use the AI/ML engine to provide the self-checkout system with an indication of whether there is an item(s) on the scale of the self-checkout system.

In some embodiments, the self-checkout system may receive an indication of whether there is an item(s) on the scale of the self-checkout system from another computing system that includes an AI/ML engine configured to perform object detection. In such embodiments, the computing system may be located on-premises or in a cloud computing environment.

In some embodiments, the self-checkout system may perform a zeroing operation of the scale of the self-checkout system upon determining that the scale is detecting a non-existent item on the scale. Such a determination may be based on obtaining (i) an indication that there is no item on the scale and (ii) an indication that a weight has been detected on the scale. In addition to performing the zeroing operation to return the scale to zero, the self-checkout system may generate and transmit an indication of the false detected weight scenario to store personnel. For example, the self-checkout system may open a support ticket for the self-checkout system to trigger store personnel and/or other technicians to check the self-checkout system.

In some embodiments, the self-checkout system may refrain from performing a zeroing operation of the scale of the self-checkout system upon determining that the scale is not detecting a non-existent item on the scale. For example, the self-checkout system may obtain an indication that there is an object or item on the scale.

Advantageously, embodiments described herein can reduce the occurrence of a self-checkout system being taken out-of-service due to false detection of item(s) on a scale of the self-checkout system. As such, embodiments can significantly increase the efficiency of the checkout process in the retail store and enhance customer experience.

Note, the techniques described herein for performing a zeroing operation of a scale of a self-checkout system may be incorporated into (such as implemented within or performed by) a variety of wired or wireless apparatuses. In some implementations, an apparatus may provide connectivity to or from a network (such as a wide area network (WAN) such as the Internet or a cellular network) via a wired or wireless communication link. In some implementations, an apparatus may include a self-checkout system.

While certain embodiments describe performing a zeroing operation for a security scale (or bagging scale) of a self-checkout system, note that the techniques described herein may be applied to other scales of a self-checkout system, such as a sales scale, as an illustrative, non-limiting example.

### Advantages of Scale Zeroing for a Self-Checkout System

A self-checkout system may include one or more scales to process a customer's transaction. In some cases, a scale(s) of a self-checkout system may false detect a weight on the scale that leads to the self-checkout system preventing the customer from continuing the transaction and to the self-checkout system being taken out-of-service. The embodiments herein provide automatic methods, e.g., without human intervention, for performing scale zeroing after detecting, using image processing, that no item is detected on the scale. Doing so can prevent a self-checkout system unnecessarily halting a customer's transaction due to false detection of weight on the scale and also reduce the occurrence of a self-checkout system being taken out-of-service.

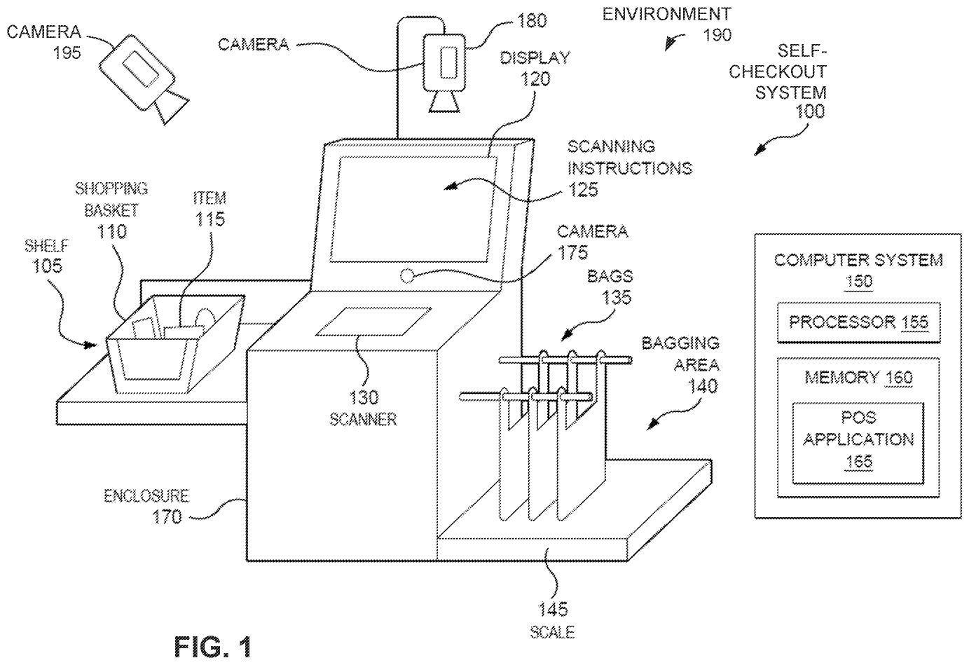

FIG. 1 illustrates a self-checkout system 100, according to one embodiment. The self-checkout system 100 may be located within an environment 190, such as a retail environment (e.g., grocery store, clothing store, electronics store, etc.).

The self-checkout system 100 includes a shelf 105 disposed on one side of an enclosure 170 and a bagging area 140 disposed on another (opposite) side of the enclosure 170. In one embodiment, the enclosure 170, the shelf 105, and the bagging area 140 are modular components—e.g., are not permanently connected to each other. As shown, relative to a customer facing the self-checkout system 100, the shelf 105 is disposed on the left hand of the customer while the bagging area 140 is disposed on a right hand of the customer. Because these components are modular, the locations of the bagging area 140 and the shelf 105 can be switched so that the bagging area 140 is disposed on the left side of the enclosure 170 while the shelf 105 is disposed on the right side of the enclosure 170. In some examples, the shelf 105 and the bagging area 140 may be connected (e.g., using fasteners or some other means). In other examples, the shelf 105 and the bagging area 140 may be connected to something besides the enclosure 170 (e.g., the floor or a frame) in order to hold these modular components in a fixed position.

The shelf 105 may be used to hold a shopping basket 110, which includes items 115 a customer wishes to purchase using the self-checkout system 100. For example, the customer may place the shopping basket 110 on the shelf 105 so the customer can easily remove and scan the items 115.

In other situations, the customer may have placed the items 115 in a shopping cart (not shown), and may use the shelf 105 to hold the items. For example, the customer may first unload the items 115 from the shopping cart onto the shelf 105 to make the items 115 more accessible during the checkout process.

A display 120, camera 175, scanner 130, and camera 180 are mounted in or on the enclosure 170. For example, the display 120 may include a display screen which permits the self-checkout system 100 to communicate with the customer. The display 120 can output price information, a purchase list, scanning instructions 125, troubleshooting instructions, and the like. In one embodiment, the display 120 is a touchscreen that allows the user to interact with functionality of the self-checkout system 100 (including POS application 165). For example, the user can use the touchscreen to select produce, cancel a scan, call for help, and select a payment method for the checkout process, as illustrative, non-limiting examples.

The scanner 130 is disposed at a top of the enclosure 170 and provides an area where the customer can move or slide the items to read a barcode on the item 115. In at least some embodiments, the scanner 130 also includes an integrated scale for weighing items such as produce (referred to herein as a “sales scale”). The embodiments herein may be used for any type of scanning technology and any number of scanners.

The camera 175 is disposed at a location on the enclosure so its FOV includes the scanner 130. That way, the camera 175 can capture images (as well as video) of a customer moving items onto and over the scanner 130. In one embodiment, the camera 175 has dual purposes. One purpose may include capturing images (as well as video) of items that do not have barcodes such as produce. An AI/ML model can be used to perform image recognition to identify the produce. This saves the customer from having to manually identify the produce for the self-checkout system 100 (e.g., select the produce from a menu on the display 120 or enter in a code).

In some cases, the images (and/or video) captured by the camera 175 can be used to determine whether an item 115 is disposed on the integrated scale of the scanner 130 (e.g., “sales scale”). For example, the images (and/or video) captured by the camera 175 can be analyzed with an AI/ML model (configured to perform object detection) to determine whether an item(s) is disposed on the integrated scale of the scanner 130. As discussed in greater detail below, in some embodiments, the self-checkout system 100 may use information indicating whether an item 115 is disposed on the integrated scale of the scanner 130 to determine whether to perform a zeroing operation of the integrated scale. For example, in certain scenarios, the integrated scale of the scanner 130 may be false detecting weight on the scale due to various factors, including malfunctioning or defective load sensor(s), environmental factors, low battery, and surface unevenness, as illustrative, non-limiting examples. In such cases, the self-checkout system 100 may be configured to automatically perform a zeroing operation of the integrated scale to return to the scale to zero upon determining that there is not an item 115 (or other object) on the scale.

The bagging area 140 includes bags 135 disposed on hangers. After scanning items 115, the customer can place the scanned items 115 in the bags 135. The bagging area 140 also includes a scale 145. The scale 145 weighs the items after being placed in the bags 135 (or in the customer's own bags if they brought them) to see if the weight of the item matches the expected weight of the item that was scanned, e.g., for loss prevention.

FIG. 1 also illustrates mounting the overhead camera 180 onto the enclosure 170. In one embodiment, the self-checkout system 100 may have one of the cameras 175 or 180, but in other embodiments, it may have both cameras or more than two cameras. In some embodiments, the environment 190 may include one or more cameras 195 that are located external to the self-checkout system 100 (e.g., the camera(s) 195 may be part of a surveillance system of the environment 190). The camera(s) 195 may be communicatively coupled to the self-checkout system 100 and/or to a computing system that is communicatively coupled to the self-checkout system 100.

In some cases, the camera 180, camera(s) 195, or a combination thereof, may be used for loss prevention. For example, the images (and/or video) captured by the camera(s) 195, camera 180, or a combination thereof, may be analyzed to determine whether a customer has moved an item 115 into the bagging area 140 (either accidently or nefariously) without first scanning that item 115 using the scanner 130. To do so, the FOV of the camera(s) 195 and/or camera 180 can include the bagging area 140 and the scanner 130, as well as other areas of the self-checkout system 100.

In some embodiments, the captured images (and/or video) from the camera(s) 195, camera 180, or a combination thereof, may be analyzed (e.g., using an AI/ML model configured to perform object detection) to determine whether an item 115 (or another object) is disposed on the scale 145 within the bagging area 140. As described in greater detail below, in some embodiments, the self-checkout system 100 may use information indicating whether an item 115 is disposed on the scale 145 to determine whether to perform a zeroing operation of the scale 145. For example, in certain scenarios, the scale 145 may be false detecting weight on the scale 145 due to various factors, including malfunctioning or defective load sensor(s), environmental factors, low battery, and surface unevenness, as illustrative, non-limiting examples. In such cases, the self-checkout system 100 may be configured to automatically perform a zeroing operation of the scale 145 to return to the scale 145 to zero upon determining that there is not an item 115 (or other object) on the scale 145.

The self-checkout system 100 also includes a computing system 150. The computing system 150 may be integrated into the enclosure 170 (e.g., as part of the display 120) or may be located external to the self-checkout system 100 but communicatively coupled to the self-checkout system 100 using, e.g., an Ethernet cable. The computer system 150 can represent any number of computing devices. For example, the computer system 150 can be implemented by a computer device disposed in the enclosure 170, can be a server that is disposed elsewhere in the environment 190, can be one or more computer devices located in a cloud computing environment, or a combination thereof.

The computing system 150 includes a processor 155 and memory 160. The processor 155 represents one or more processing elements which each can include one or more processing cores. The memory 160 can be volatile memory, non-volatile memory, and combinations thereof. The memory 160 includes various instructions that are executable by the processor 155 to perform one or more techniques described herein. Here, the memory 160 includes a POS application 165 (e.g., a software application) that controls the operations of the self-checkout system 100. For example, the POS application 165 can include any number of software modules (or a suite of software applications) that communicates with the scanner 130 (as well as the integrated scale therein), cameras 175, 180, and 195, the display 120, the scale 145, a POS device integrated with or located in proximity to the self-checkout system 100, and other components in the self-checkout system 100. The POS application 165 can receive input from these components as well as send instructions.

The POS application 165 can determine whether an item 115 (or other object) is located on a scale (e.g., integrated scale of scanner 130 and/or scale 145) of the self-checkout system 100. In one embodiment, the POS application 165 may analyze images (and/or video) captured by one or more cameras (e.g., camera 175, camera 180, camera(s) 195) with an AI/ML model configured to perform object detection to determine whether an item 115 (or other object) is located on the scale. In another embodiment, the POS application 165 may receive an indication of whether an item 115 (or other object) is located on the scale. For example, the camera(s) and/or another computing system may analyze the captured images (and/or video) and provide an indication to the POS application 165 of whether an item 115 (or other object) is located on the scale.

If the POS application 165 detects that the scale (e.g., integrated scale of scanner 130 or scale 145) of the self-checkout system 100 is measuring a weight and determines there is no item on the scale, then the POS application 165 may perform a zeroing operation of the scale to return the scale to zero. As noted, the zeroing operation may involve determining a false detected weight on the scale, setting a “temporary zero weight” parameter of the scale equal to the false detected weight, and resetting the weight of the scale to a difference between the temporary zero weight parameter and the false detected weight. In addition to performing the zeroing operation, the POS application 165 may generate a log entry to alert and trigger store personnel or technician to perform maintenance on the scale, e.g., to resolve any underlying factor that caused the false detection of weight by the scale.

If the POS application 165 detects that the scale is measuring a weight and determines there is an item on the scale, then the POS application 165 may refrain from performing a zeroing operation of the scale. In such cases, the POS application 165 may display, as part of the scanning instructions 125, a request for the customer to remove the item 115 or object from the bagging area 140.

Note that FIG. 1 illustrates a reference example configuration of a self-checkout system 100 in which the techniques presented herein can be implemented and that other configurations of the self-checkout system consistent with the functionality described herein are contemplated.

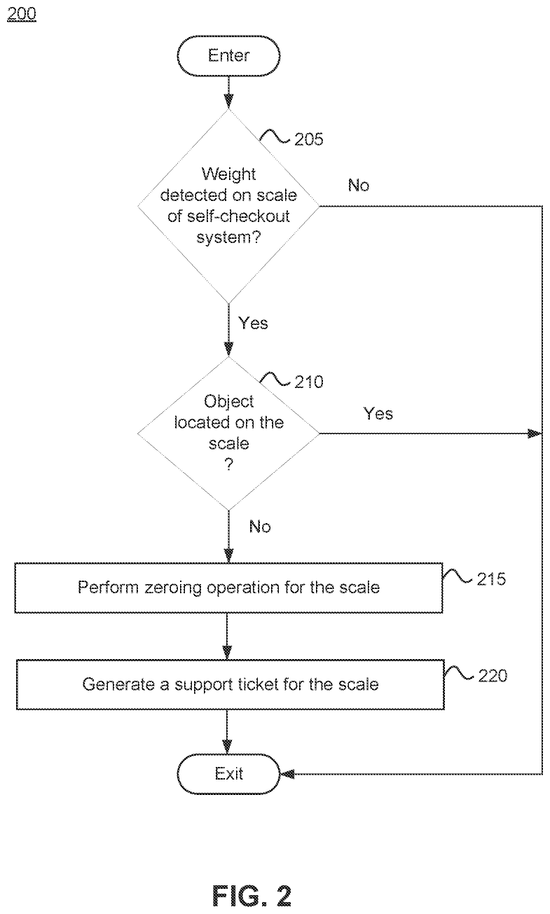

FIG. 2 is a flowchart of a method 200 for performing zeroing of a scale of a self-checkout system, according to one embodiment. Method 200 may be performed by a self-checkout system (e.g., self-checkout system 100 including one or more components thereof). In some cases, method 200 may be performed while the self-checkout system is in service, while a customer is in the process of using the self-checkout system to purchase items, or a combination thereof.

Method 200 enters at block 205, where the self-checkout system 100 determines whether a weight is detected on a scale of the self-checkout system. The scale may be a sales scale of the self-checkout system (e.g., integrated scale of scanner 300), a security scale (or bagging scale) of the self-checkout system (e.g., scale 145), or a combination thereof. The self-checkout system 100 may communicate with the scale, e.g., via POS application 165, in order to determine the current weight detected on the scale. For example, the POS application 165 may query the scale 145 for information regarding the weight being detected on the scale, or otherwise have access to the information regarding the weight being detected on the scale.

If, at block 205, the self-checkout system determines that a weight is not detected on the scale of the self-checkout system, then the method 200 exits. On the other hand, if at block 205, the self-checkout system determines that a weight is detected on the scale of the self-checkout system, then the method 200 proceeds to block 210. At block 210, the self-checkout system determines whether an object is located on the scale. The object, for example, may be an item associated with the environment 190 (e.g., retail store), such as item 115, or another object unassociated with the environment 190 (e.g., an object not available for purchase, such as the customer's purse, an object within the customer's purse, or any other type of object).

In some embodiments, the self-checkout system may determine whether an object is located on the scale based on evaluating captured images (and/or video) of the scale with an AI/ML model configured to perform object detection. In this embodiment, the self-checkout system may capture one or more images (and/or video) of the scale via a camera (e.g., camera 175, camera 180, camera(s) 195), analyze the captured images (and/or video) (via the POS application 165) with an AI/ML model configured to perform object detection, and determine (via the POS application 165) whether there is an object on the scale, based on the analysis.

In some embodiments, the self-checkout system may determine whether an object is located on the scale based on an indication obtained from the camera. For example, the camera (e.g., camera 175, camera 180, camera(s) 195) may include an AI/ML model configured to perform object detection. In such examples, the camera may analyze images (and/or video) captured of the scale with the AI/ML model and provide an indication to the (POS application 165 of the) self-checkout system of whether there is an object on the scale.

In some embodiments, the self-checkout system may determine whether an object is located on the scale based on an indication obtained from a computing system configured to perform object detection using AI/ML models. Such a computing system may obtain captured images (and/or video) of the scale from the camera(s), analyze the captured images (and/or video) with an AI/ML model, and provide an indication to the (POS application 165 of the) self-checkout system of whether there is an object on the scale.

Note, the techniques described herein may employ a variety of computer vision algorithms and deep learning methodologies for object detection and image processing. For example, the AI/ML model(s) employed herein for objection detection and image processing may include, but are not limited to, histogram of oriented gradients (HOG), region-based convolutional neural networks (R-CNN), faster R-CNN, single shot detector (SSD), you only look once (YOLO), and RetinaNet, as illustrative, non-limiting examples.

If, at block 210, the self-checkout system determines that an object is not located on the scale, then the method 200 exits. On the other hand, if at block 210, the self-checkout system determines that an object is located on the scale, then the method 200 proceeds to block 215. At block 215, the self-checkout system performs a zeroing operation for the scale. As part of the zeroing operation, the self-checkout system may involve determine a false detected weight on the scale, set a “temporary zero weight” parameter of the scale equal to the false detected weight, and reset the weight of the scale to a difference between the temporary zero weight parameter and the false detected weight.

At block 220, the self-checkout system generates a support ticket for the scale. For example, the self-checkout system may generate the support ticket to alert store personnel to a potential issue regarding the scale and to trigger store personnel to resolve the potential issue. In some cases, for example, the scale may be false detecting weight due to factors, such as malfunctioning or defective load sensor(s), environmental factors, low battery, and surface unevenness, as illustrative, non-limiting examples. Note, however, that in some embodiments, method 20 may be performed without generating a support ticket in block 220.

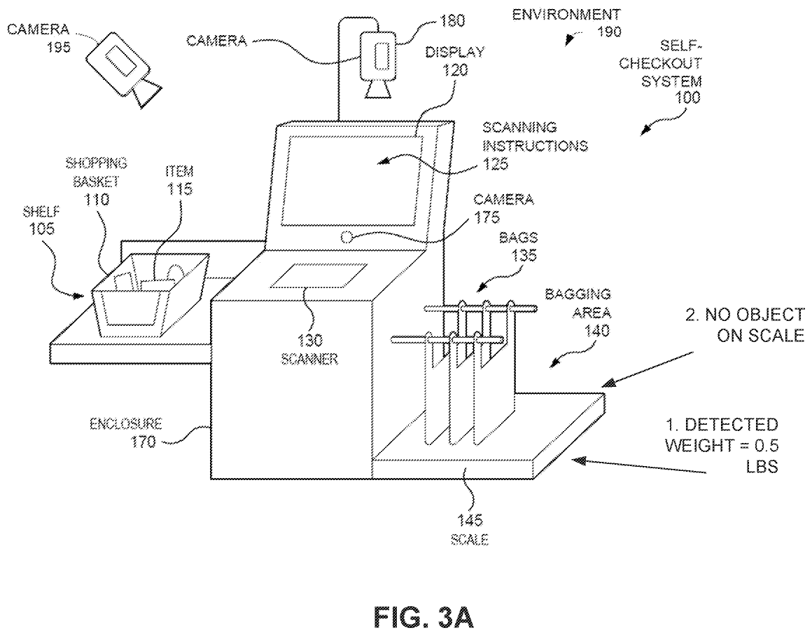

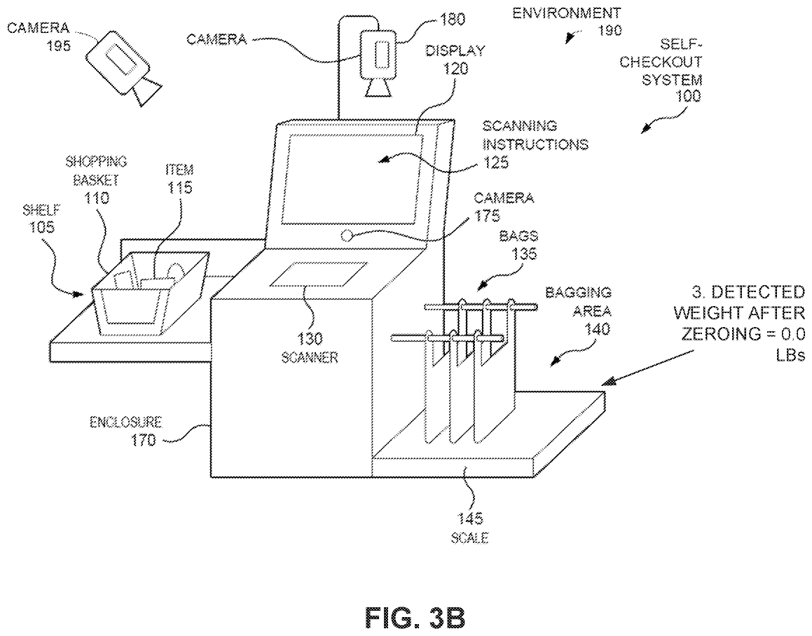

Consider the example scenario depicted in FIGS. 3A and 3B. As shown in FIG. 3A, the self-checkout system 100 may detect a weight of 0.5 pounds (lbs) on scale 145 and determine that there is no object on the scale. As shown in FIG. 3B, after detecting the weight on scale 145 and determining there is no object on the scale, the self-checkout system 100 may perform a zeroing operation for the scale 145 to return the scale to a detected weight of 0.0 lbs.

Advantageously, embodiments described herein can reduce the occurrence of a self-checkout system being taken out-of-service due to false detection of item(s) on a scale of the self-checkout system. As such, embodiments can significantly increase the efficiency of the checkout process in the retail store and enhance customer experience.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to the described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s). Additionally, when elements of the embodiments are described in the form of “at least one of A and B,” or “at least one of A or B,” it will be understood that embodiments including element A exclusively, including element B exclusively, and including element A and B are each contemplated.

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged for the computing resources actually used (e.g. an amount of storage space consumed by a user or a number of virtualized systems instantiated by the user). A user can access any of the resources that reside in the cloud at any time, and from anywhere across the Internet. In context of the described embodiments, a user may access applications (e.g., POS application 165, AI/ML model(s)) and/or related data (e.g., captured images and/or video) available in the cloud. For example, the POS application 165 could execute on a computing system in the cloud and perform one or more techniques described herein for performing scale zeroing for a self-checkout system (e.g., self-checkout system 100). In such a case, the POS application 165 could access an AI/ML model in the cloud and evaluate captured images and/or video using the AI/ML model. The POS application 165 could store an indication of whether an object is detected on a scale(s) of the self-checkout system at a storage location in the cloud. Doing so allows a user to access this information from any computing system attached to a network connected to the cloud (e.g., the Internet).

While the foregoing is directed to one or more embodiments, other and further embodiments may be devised without departing from the basic scope thereof, and the scope thereof is determined by the claims that follow.

What is claimed is:

1. A computer-implemented method comprising:
detecting a weight on a scale of a self-checkout system;
determining there is no object located on the scale; and
responsive to detecting the weight on the scale and determining there is no object located on the scale, performing a zeroing operation of the scale.

2. The computer-implemented method of claim 1, further comprising generating a support ticket for the scale responsive to detecting the weight on the scale and determining there is no object located on the scale.

3. The computer-implemented method of claim 1, further comprising:
capturing one or more images of the scale; and
analyzing the one or more images with a machine learning (ML) model to determine whether there is an object located on the scale.

4. The computer-implemented method of claim 3, wherein determining there is no object located on the scale comprises determining, based on the analysis, that no objected is located on the scale.

5. The computer-implemented method of claim 1, wherein determining there is no object located on the scale comprises receiving an indication from at least one computing device that there is no object located on the scale.

6. The computer-implemented method of claim 5, wherein the at least one computing device comprises a camera coupled to the self-checkout system, the camera having a field-of-view of the scale of the self-checkout system.

7. The computer-implemented method of claim 5, wherein the at least one computing device comprises a camera deployed in an environment comprising the self-checkout system, the camera being communicatively coupled to the self-checkout system and having a field-of-view of the scale of the self-checkout system.

8. The computer-implemented method of claim 1, wherein the scale is an integrated scale of a scanner of the self-checkout system or a bagging scale located in a bagging area of the self-checkout system.

9. A self-checkout system, comprising:
a bagging area;
a scale disposed in the bagging area; and
a computing system for controlling the self-checkout system, the computing system configured to:
detect a weight on the scale;
determine there is no object located on the scale; and
responsive to detecting the weight on the scale and determining there is no object located on the scale, perform a zeroing operation of the scale.

10. The self-checkout system of claim 9, wherein the computing system is further configured to generate a support ticket for the scale responsive to detecting the weight on the scale and determining there is no object located on the scale.

11. The self-checkout system of claim 9, further comprising a camera configured to capture one or more images of the scale, wherein the computing system is configured to analyze the one or more images with a machine learning (ML) model to determine whether there is an object located on the scale.

12. The self-checkout system of claim 11, wherein the computing system is configured to determine, based on the analysis, that no object is located on the scale.

13. The self-checkout system of claim 9, wherein the computing system is configured to receive an indication from at least one computing device that there is no object located on the scale.

14. The self-checkout system of claim 13, further comprising a camera having a field-of-view of the scale, wherein the at least one computing device comprises the camera.

15. The self-checkout system of claim 13, wherein the at least one computing device comprises a camera deployed in an environment comprising the self-checkout system, the camera being communicatively coupled to the self-checkout system and having a field-of-view of the scale.

16. A non-transitory computer-readable medium comprising computer-executable instructions, which when collectively executed by one or more processors of a computing system cause the computing system to perform an operation comprising:
detecting a weight on a scale of a self-checkout system;
determining there is no object located on the scale; and
responsive to detecting the weight on the scale and determining there is no object located on the scale, performing a zeroing operation of the scale.

17. The non-transitory computer-readable medium of claim 16, the operation further comprising generating a support ticket for the scale responsive to detecting the weight on the scale and determining there is no object located on the scale.

18. The non-transitory computer-readable medium of claim 16, the operation further comprising
capturing one or more images of the scale; and
analyzing the one or more images with a machine learning (ML) model to determine whether there is an object located on the scale.

19. The non-transitory computer-readable medium of claim 18, wherein determining there is no object located on the scale comprises determining, based on the analysis, that no objected is located on the scale.

20. The non-transitory computer-readable medium of claim 16, wherein determining there is no object located on the scale comprises receiving an indication from at least one computing device that there is no object located on the scale.
